(19) United States
(12) Patent Application Publication
(10) Pub. No.: US 2017/0011720 A1
(43) Pub. Date: Jan. 12, 2017

(54) Guitar pick

(71) Applicant: Steven Patrick Pascale, San Clemente, CA (US)

(72) Inventor: Steven Patrick Pascale, San Clemente, CA (US)

(21) Appl. No.: 14/545,928

(22) Filed: Jul. 9, 2015

(51) Int. Cl. G10D 3/16

(52) U.S. Cl. CPC G10D 3/163

(57) ABSTRACT

An equilateral guitar pick uniquely designed for“variability and versatility” strumming. Furthermore, the apparatus shape is ergonomically designed to incorporate human factors i.e. musical transfer of energy from pick to strings in an optimum manner.

The apparatus picking surface and corresponding tip(s) can incorporate an array of material(s) while utilizing a rubber-like plane grip. Moreover, the invention contains 3 concentric planes with at least 1 plane being defined with a continuous rounded edge-surface that is inclusive of tip. Collectively, the guitar pick has three different radius tips located with a specific radial(s) positioned at 360-135-225 degrees (relative to a cardinal compass) and has a predetermined distance from tip to center point.

Moreover, each concentric plane edge runs along the picks longitudinal as well as lateral axis and can utilize different materials as well as gauge. Rotation of the guitar pick i.e. moving from concentric plane to plane . . . is achieved utilizing 3 inner half circle grooves that are geometrically relational to the union between each plane.

### BACKGROUND OF THE INVENTION

1. Field of The Invention

The present invention relates generally to accessories for music instruments; particularly, a guitar pick.

2. Description of Related Art

Finger picks vary tremendously. Finding the perfect pick is sometimes like finding the perfect guitar—you have to try a lot of them until you find the right one. Prior patents elaborate on manufacturing picks with several types of resilient materials including plastic. For many guitarist, the ultimate pick material might very well be tortoise shell, but this is no longer available. Today, a proprietary material that incorporates a hybrid of varying degrees of nitrocellulose and camphor, Delrex, poly carbonate as well as nylon makes for an ideal composition.

Musicians alike would all agree that the guitar plectrum is a very an important tool. Some would go to the extent to say that a pick has the biggest impact on both tone as well as technique. In particular, striking strings sets the audio signal in motion.

With this in mind, playing in a linear single-note legato fashion . . . minimizes the crisp attack that maybe heavier picks impart. Upstroke ghost notes . . . to rhythm, a thinner pick provides a more ethereal subtlety or keeps a battery of eighth-notes going in order to build tension. That said, regardless of the genre of music played, a pick provides an essential tonal foundation.

Indeed, companies like Fender, Dunlop, D'Andrea and Ernie Ball have been around for decades. Newer companies are emerging that include Dava, Red Bear Trading, Clayton, V-Picks, Wegen, JB, Blue Chip, Golden Gate, Pick Boy, Wedgie and more. Generalizations about technique and materials are plentiful. By and large, most electric guitarists use some form of plastic or nylon. Luigi D'Andrea first began making guitar picks from cellulose acetate back in 1922. To this day it has remained one of the standard materials for guitar picks. Along the same lines, Ernie Ball's standard line of Cellulose Acetate Nitrate picks are also common place. Some pick purists swear by Dunlop's Tortex line which is made from plastics to emulate properties found in a turtle shell . . . In other cases, polymerized animal protein has been known to simulate the same. Likewise, nylon picks have been used by many including Jimmy Page, Dave Gilmour, and Gene Simmons. Nylon arguably has a brighter sound and also has more flexibility than comparable thick plastic pick. So looking back, nylon may appeal to players who's aim includes a more vintage sound as they seem less suited to the kind of compressed tone and tight rhythm phrasing that modern rock gravitates towards.

Indeed, a thinner gauge tends to be more flexible and produces a wide range of sounds from soft to loud, but also produces a click that emphasizes the attack of the pick. On the other hand, a heavier (thicker material gauge) pick will tend to produce a brighter tone.

Meanwhile, exotic materials can produce aesthetically beautiful alternative tones. These guitar picks may include: lignum vitae wood, zebrawood, walnut, bubinga and gemstones. In general, the harder and denser the material, the more crisp and cutting the resulting sound.

Examples of conventional finger picks for playing stringed musical instruments may be seen by referring to one or more of the following United States patents:

U.S. Pat. No. 1,547,560 Burdwise July 1925; U.S. Pat. No. 1,787,136 Beauchamp December 1930; 201648 Kealoha October 1935; U.S. Pat. No. 3,442,169 Bowers May 1969; U.S. Pat. No. 3,739,681 Dunlop June 1973 U.S. Pat. No. 3,735,663 Cowell May 1973; U.S. Pat. No. 4,102,234 Brundage July 1978; U.S. Pat. No. 4,270,433 Adamec June 1981; U.S. Pat. No. 5,509,341 Dunlop April 1996

Whatever the material, a thinner pick—somewhere between 0.40 and 0.65 mm for more standard materials like Delrin and nylon—will generally have a lighter sound and often works better for acoustic strumming where a more trembly tone is desired. The classic strummed acoustic guitar zing sound is useful in rock, pop, and country recordings for filling in a midrange and helping to define rhythms. Conversely, thin picks make little sense for rock rhythm guitars or lead; however, as they deliver very little bass or midrange tone and simply lack the heft necessary to bring out a well-rounded tone on single-note leads. For that, a step up to a medium gauge pick is warranted and is generally in the range of 0.60 to 0.80 mm. Medium remains the most popular thickness because it's the perfect combination of stiffness and flexibility for rock rhythm in addition to full bodied acoustic accompaniment (especially in solo situations). What's more, thicknesses ranging from 0.70 mm-0.99 will have enough heft to produce powerful tones on leads and hook figures. In all, medium picks tend to help produce a good blend of high-end and lower mid-range thump, without being too shrill.

Finally, for heavier sounds . . . a material gauge ranging from 1.05 mm-1.35 mm works well while still flexible enough to crunch rhythms and at the same time firm enough for full-bodied chord arpeggios and fat lead lines. It's noteworthy just how much one's tone changes in switching from a medium to a thick pick. At the thicker end, 1.5 and over is an ideal thickness for bebop and jazz—sounds that are increasingly mellow and burnished.

Electric players who want more precision and control will gravitate toward heavier picks with a pointier tip.

And so, a need exists for a guitar pick that includes an equilateral shape which offers multiple tips to accommodate more than one playing style.

Although it's probably one of the most overlooked aspects of a pick selection . . . from a tonal perspective, the texture of a picks surface can also be important. Many pick designs including Dunlop's traditional Nylon and max grip picks are intended to help maintain a better hold.

In summary, a picks characteristics are associated with the style of music being played. Ultimately, an acoustic chord strummer will generally want to use a thin pick, probably one made of cellulose, Delrin, or imitation tortoiseshell. Acoustic flat-pickers engaging in a more intricate style and while playing single note lines will prefer something a bit more rigid, perhaps a medium or a heavier gauge. Electric rock players certainly favor medium to heavy gauge picks with either a rounded or a sharp tip. Classic and rock players typically use nylon or cellulose, while metal and grunge aficionados steer toward Derlin or even acrylic. As mentioned, regardless of genre, if accuracy and precision are important, a hard pick is preferred.

### SUMMARY OF THE INVENTION

According to the first embodiment of the invention, a finger pick is disclosed for plucking or strumming a guitar. The apparatus seen provides a novel ergonomic design which was enthusiastically received during primary market research studies.

In another embodiment, the pick depicts different radius tips located on 2 of the 3 concentric planes in an unbounded two-dimensional shape. Equilateral, each concentric circle in part or collectively is made up of durable material and/or hybrid and accompanied with a silicone like rubber grip. Furthermore, each concentric plane has at least 1 radius, wherein the center point has an approximate equal distance to its upper, lower, right and left edges. Three different tips are defined about a 360 degree radial pick edge, further made up of 3 different material gauge(s). Furthermore, one concentric plane also has a tip having a 10 degree angle approximately perpendicular to its respective edge.

Geometrically relational to the apparatus center-point are 3 inner half recessed grooves that defines a union between each of the three concentric planes, collectively comprising in-part or as a whole, a rotational wheel used for rapid transition between use of the first radius end point, second, or third planar tips, implemented by repositioning the picks center portion about the distal phalanges of the finger and guitar players thumb. Again, the materials used per concentric plane can vary.

The tips shown in another embodiment depicts 3 respective radius's on said guitar pick. Yet another embodiment, an inner portion is shaped uniformly and semi-triangular and was designed to create a more sensitive touch. At the same time, a front or back surface is ideal for imprinting.

In another embodiment, the invention provides a means for storing a guitar pick. The advantage of this includes having easy accessibility to a spare. The materials used for the holder allows for permanent as well as non-permanent (dry/wet-erase) marker use.

A better understanding of the present invention will be understood upon reference to the following detailed description when read in conjunction with the accompanying drawings; wherein features and advantages will illustrate, by way of example, the principles of the invention.

### BRIEF DESCRIPTION OF THE DRAWINGS

FIG. 1 is a front view of the guitar pick in accordance with the invention.

FIG. 2 is a rear view of the guitar pick shown in FIG. 1.

FIG. 3 is a perspective front view of the apparatus front-side shown in FIG. 1.

FIG. 4 is a front view of the pick's back surface shown in FIG. 1.

FIG. 5 is a front view of the guitar pick tips and corresponding radius(s).

FIG. 6 is a front view of FIG. 3 according to an alternative embodiment.

FIG. 7 is a frontal view of the guitar pick holder.

### DETAILED DESCRIPTION

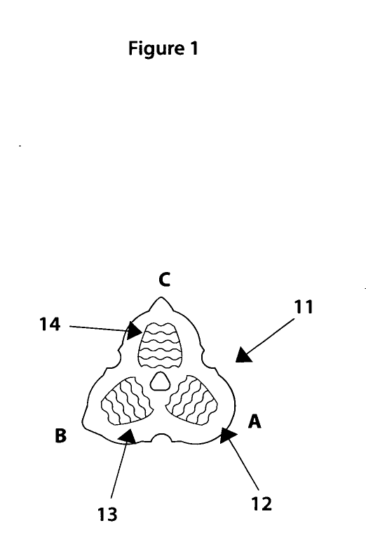

A guitar pick according to a first embodiment referenced in FIG. 1. The pick 11 shown illustrates an apparatus with a somewhat triangular shape that is designed to be held between the guitar players thumb and finger(s). Other designs, materials, and combinations are possible and this disclosure is not meant to be limiting to the invention described herein. The invention . . . 11 is comprised of 3 concentric planes which are approximately 0.750 inches from side to side and are noted herein as 12, 13, and 14.

The material used for 12 may very well be a hybrid that combines Delrin, Dunlop, and polymerized animal protein. Likewise, 13 may also utilize a hybrid that may combine various types of plastic or acrylic, Delrin, cellulose. Material used in 14 may be a single material and/or is a hybrid of thermoplastic composition including: nylon, cellulose, and various acetate-nitrates.

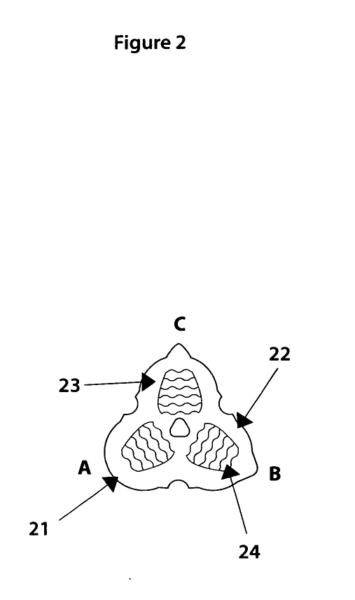

FIG. 2 illustrates has a round concentric plane radius that defines a tip 21 with a thickness of approximately 0.65 mm. As illustrated, 23 has a more pointed tip and has a material gauge of 1.15 mm. Furthermore, 22 has an even a more acute tip that is “arrow-like” and has a material gauge of 1.50 mm. Yet, another embodiment might“call-out” a gauge that is intended for playing an electric guitar i.e. 21 as 0.90 mm, 22 a gauge of 1.35 mm, and 23 a gauge of 1.90 mm.

On the other hand, a lead guitarist that is shredding, playing rhythm or riffs, thrash metal is more opt to insist on 1 gauge for all 3 concentric planes. In this configuration, the material thickness might be offered in 0.65 mm, 0.95 mm, and 1.15 mm. And for picking at higher tempos, a 10 degree angle (53 and 61) allows the plectrum to slightly cut across the strings rather than flat against them. The idea is to reduce as much obstruction as possible . . . allowing only the arrow-like tips of the invention 52/53 to scratch over the guitar strings.

As best shown in 24, each individual concentric plane has a grip shown with a designated pattern which stems outward from the mid point of said pick, the grip is situated approximately ⅛″ from the bottom corner of the other 2 grip base-sections, said surfaces raised with a “rubber-like” silicone material.

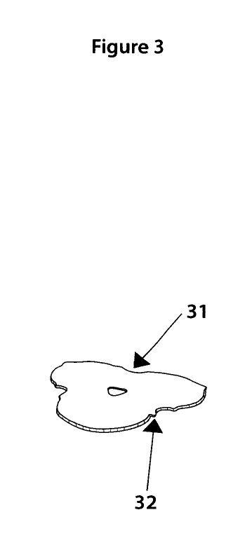

As best shown in FIG. 3, the pick's rotation wheel allows a guitar player to transition from one concentric plane“tip” to another while in play. Designed with human factors in mind, the recessed indented finger allows for movement of the pick to to a desired tip at either 360, 135, 225 degree position. Selection of a given tip and corresponding gauge is based on a style of play desired. Said recess openings 31, 32 and 44 functionally assist a guitar player to rotate pick either clockwise and/or counter clockwise pending on a subsequent style and tone desired. The lip of the wheel seen in 32 is a geometrical union between 2 concentric planes. If the invention is made of varying gauge(s), the transition is also felt by the slight gradation in material thickness.

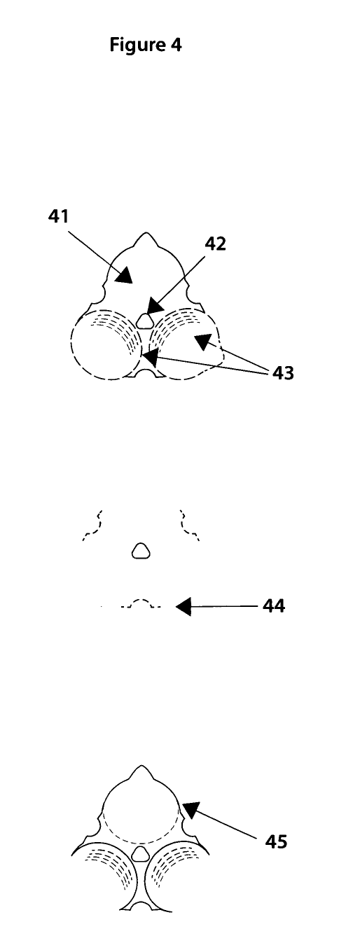

FIG. 4 shows three different illustrations. The first illustration coextensively frames the pick's rotation wheel showing all 3 concentric planes. This embodiment particularly depicts 41 as the only concentric plane which is incorporated into said rotational wheel frame; thus, having a like material and gauge.

In the middle of the rotation wheel is an urn-filled center 42 . . . void of material and designed accordingly to enhance the overall gripping function. Uniform in shape, when combined with 24 . . . the pick firmly remains in the hand of guitar player.

Now, turning our attention to 43, two concentric planes ideally made up of a hybrid material and multi-gauge thicknesses are illustrated with dashed lines. Notably, 41 is the only plane that has the same dimensions as that found on the rotational wheel frame. As seen in 45, the concentric plane with the most pointed “arrow-like” tip is in fact part of the frame and may or may not have the thickest gauge when compared to the other 2 concentric planes.

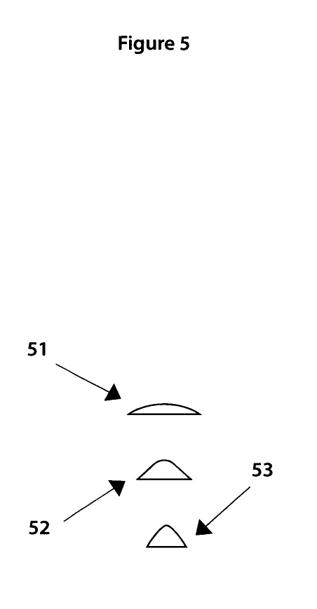

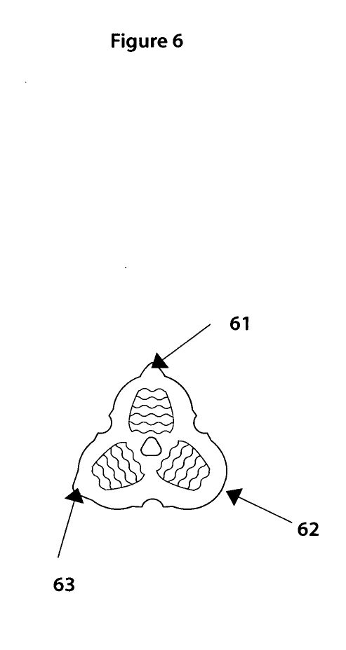

FIGS. 5 and 6. Referring to FIG. 5, there are 3 different radius tips shown i.e. 51, 52, and 53. Each radius is manufactured with specific metrics that will vary pending upon the specific intended use and tone requirements. Likewise, FIG. 6 displays an example of representative tip to its corresponding concentric plane as seen in 61, 62, and 63.

In accordance with this embodiment, 61 depicts the most pointed “pick tip” . . . out of the 3 concentric planes. In particular, a tip may or may not have a tip that is angled relative to the user's finger; allowing for a style of play that is somewhat different. Like 31 . . . which depicts the rotational wheel edge, 61, 62, and 63 may or may not be beveled pending on the intended purpose of said chamfer i.e. an overlap that is used to soften the edge which comes in contact with a guitar string.

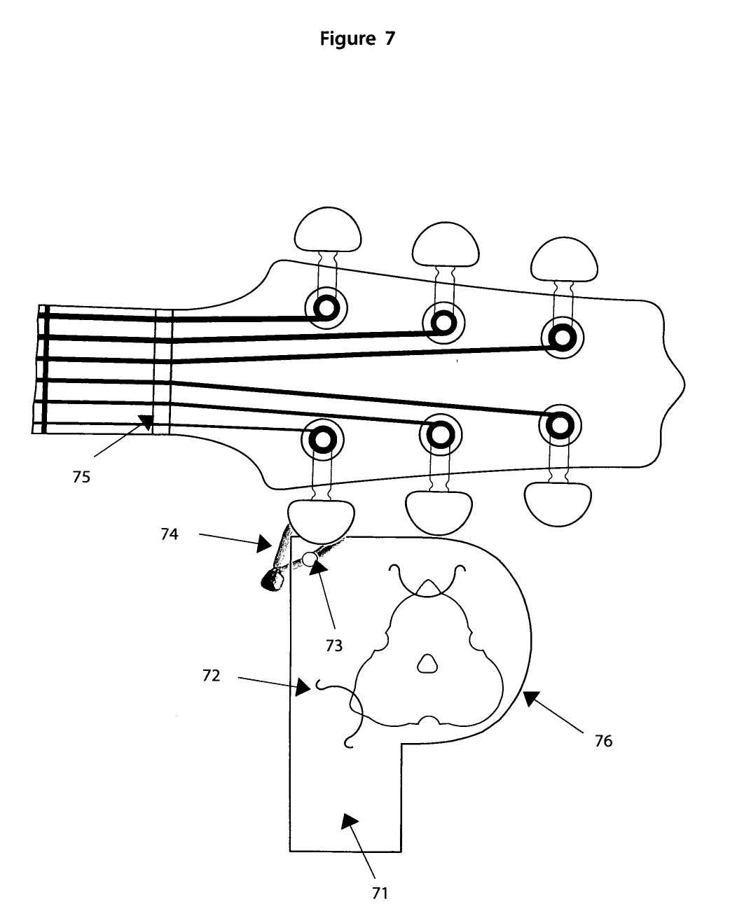

Referring now to FIG. 7, one embodiment of a guitar pick holder 76 is shaped like a “P”. Approximate dimension are 3″×2 2/8″. Said guitar pick fits within the designated hoop like clips. Furthermore, the guitar pick holder is made of a material that provides both pliability and bend-ability. Ideally, two card stock sheets are mounted whereby one or both sides may or may not provide specific brand advertisement. In parallel, a thin magnetic material can also be mounted i.e. securely affixed to backside. Moreover, a polypropylene (plastic polymer) can be applied to one or both surfaces in order to increase the apparatus thickness, water-proofing, and/or adding additional rigidity.

Affixed to the body of the pick holder is a unique “die-cut” resembling a flange 72 that when pressed upward allows for said pick tip to be placed securely. The two flanges act as a clip, holding 2 concentric planes with outward arrow-like pick tips. One flange is formed on the neck portion 71 of said “P” apparatus while the other is contained in the upper curvature section . . . 76. When the guitar pick is not in the “holder clip mechanism”, the flanges fall back into a neutral position. Another feature 73 . . . shows an aperture in the upper left region of the apparatus and is used for attaching a string 74 thereon; enabling further attachment to a guitar. The shape itself “P” is intended to simply reinforce the obvious “Pick”

The holders functional strength is provided by surface area as well as material grain direction and the orientation in which it is die-cut in order to achieve a specified rigidity i.e. bending of the flange-like hoops up and/or down without compromising the integrity of the material. The holder can also be placed under the guitar strings 75 . . . where the apparatus has a magnetic contact surface and is thereby easily attached to a guitar's metal frets.

Having thus set forth the preferred embodiments, what is claimed:

1. An guitar pick for playing music—producing sounds from one or more vibrating strings. Said pick comprising of:
A pick having a front and a back surface ideally 1.4375″ in width and 1.41″ in height; and
3 Concentric planes wherein at least 1 plane has a continuous and circular outer edge radius surface; and
A pick frame with 3 recessed grooves used for rapid rotation (wheel) yielding a variation in sound when a transition is initiated by using one concentric plane tip to another; and
A concentric plane (with or without tip) thickness that is the same or similar to the gauge of the other 2 Concentric planes; and
Each of 3 concentric planes and corresponding tips having dissimilar thicknesses; and
A front and/or back surface used for custom imprinting.

2. The invention as defined in claim 1, wherein a concentric plane utilizes a specific material or hybrid combination consisting of compound layer(s) of plastics, woods, and metals which is used for a specific designated playing purpose; said materials to notably include: Delrex, Celluloid, Nylon, Ultem, Tivar, Techron, Ketron, heat tempered acrylic, acetate, carbon fibers, or polymerized animal protein; each concentric plane having same or a dis-similar material type; and

3. The invention as defined in claim 1, wherein each concentric plane comprising of different equilateral tips with varying degrees of radius for distinctly variant purposes of plucking with dynamic expression, or strumming strings wherein a tip can have a beveled edge that combines a positive union with smooth string release.

4. The invention as defined in claim 3, wherein a concentric plane can have a tip angled approximately 5-20 degrees allowing for a more comfortable hand position coupled with quicker string contact.

5. The invention as defined in claim 1, wherein a pick body contains a center portion void of material and uniformly triangular with round corners—creating an incredibly aggressive grip and fingertip touch allowing for an enhanced sensitivity and means to vary string attack by adjusting and/or applying different degrees of finger pressure, said material around the picks frame-center remains rigid enough so that it doesn't bend to the extent that it takes an extra fraction of a second for it to come back to its natural point of rest, and used to apply a compressive force upon the thumb and finger . . . gripping the same in order to get to the core of the tone.

6. The invention as defined in claim 1, wherein a silicone—rubber grip that is non-sticky, thin, comfortable while holding the pick . . . producing better articulation and reducing fatigue; a high friction coating portion has a raised-like surface to the picks body, said grip can be seen on one or all 3 concentric planes; thereby, allowing for greater pick control.

7. A guitar pick holder wherein an apparatus is approximately 3″ in height and 2.5″ in width; and has an aperture in upper corner for attaching a string or elastic band—a means of attaching or storing a pick around one of the tuning keys in a manner which does not interfere with playing.

8. The invention in claim 7 wherein, said pick holder is comprised of either plastic (approximately 1/16″ thick) and/or, card stock that is ideally between point 32 and 50, ideally laminated with polypropylene on one or both sides (synthetic or semi-synthetic organic material that resembles non-crystalline substance), accommodating a writing platform such that a permanent or non-permanent marker can be used thereon.

9. The invention in claim 8 wherein, said holder is designed in the shape of a “P” and pliant enough to flexibly bend 2 different flange-like rims used for pick retention purposes.

10. The invention in claim 9 wherein, the pick holder backside surface is further comprised of a thin magnetic material backing capable of attaching to a guitar neck—frets.
